(19) United States
(12) Patent Application Publication
(10) Pub. No.: US 2016/0158605 A1
(43) Pub. Date: Jun. 9, 2016

(54) COLOR GOLF BALL CONSTRUCTIONS HAVING AT LEAST ONE CONTRASTING AND DISTINCT COLOR APPEARANCE FORMED IN A SURFACE

(71) Applicant: ACUSHNET COMPANY, Fairhaven, MA (US)

(72) Inventor: William E. Morgan, Rehoboth, MA (US)

(73) Assignee: ACUSHNET COMPANY, Fairhaven, MA (US)

(21) Appl. No.: 14/564,328

(22) Filed: Dec. 9, 2014

(51) Int. Cl. A63B 43/00; A63B 45/00; B29C 33/56; B29C 45/16; B29C 45/26; B29C 39/02; B29C 39/12; B29C 43/20; A63B 37/00; B29C 43/02

(52) U.S. Cl. CPC A63B 43/008; A63B 37/0003; A63B 45/00; B29C 33/56; B29C 43/027; B29C 45/26; B29C 39/028; B29C 39/12; B29C 43/20; B29C 45/1679; B29K 2075/00

(57) ABSTRACT

A golf ball of the invention has an overall color appearance formed from the following steps. A cover material for forming a golf ball cover is provided having a first color appearance that contributes to the overall color appearance. A color material having a second color appearance that contributes to the overall color appearance is applied in discrete locations on a surface of a mold. The cover material is provided into the mold adjacent the color material, an a cover molding process is performed to form a molded cover surface such that: during the cover molding process the color material is transferred to the cover material and incorporated into the molded cover surface; and the molded cover surface comprises at least the first color appearance and the second color appearance, wherein the first color appearance is different than the second color appearance.

### FIELD OF THE INVENTION

Golf balls comprising at least two different color appearances which contribute to an overall golf ball color appearance, and methods of making same.

### BACKGROUND OF THE INVENTION

Golf balls generally comprise a core surrounded by a cover and optionally intermediate layers there between. The cover forms a spherical outer surface and typically includes a plurality of dimples. The core and/or the cover may incorporate multiple layers and the core may be solid or have a fluid-filled center surrounded by windings and/or molded material. Golf ball covers may be formed from a variety of materials such as balata, polyurethane, polyurea, and/or thermoplastic compositions, and ionomer resins such as SURLYN® and IOTEK®, depending upon the desired performance characteristics of the golf ball and desired properties of the cover.

While conventional golf balls are white, some golfers enjoy distinguishing themselves on the course by playing a golf ball having a unique visual appearance. Accordingly, golf ball manufacturers have incorporated color and other aesthetically pleasing characteristics into golf balls. In one approach, coloring agents such as pigments, dyes, tints, inks and the like are mixed/blended directly into the golf ball layer composition (herein, layers being any or all of inner cores (which are typically substantially spherical), intermediate layers (e.g. outer core layers and/or inner cover layers), outer cover layers and/or coating layers.

Meanwhile, manufacturers also began applying localized distinctive multi-colored markings to golf ball surfaces. In one example, multi-color indicia/markings such as a trademark, logo, design, identification number, model name and/or number were provided onto a golf ball surface by applying an inked prefab printing plate or stamp onto a limited portion of the golf ball surface. More recently, prefab multi-color digital images have even been created, uploaded into a program, and applied to a localized portion of the surface of a golf ball via a printer.

Golf balls incorporating more expansive multiple distinct color appearances are also known. In one approach, a portion of a golf ball surface is masked while another portion remains unmasked, with the unmasked portion being painted a color that differs from the color appearance of the masked surface portion. In another approach, a two color golf ball appearance is created by mating two differently colored half-shells to form a golf ball layer wherein a first half of the layer has the first color appearance and a second half of the layer comprises the second color appearance. It was then discovered that multiple layers of differently colored mated parts could be positioned and aligned about one another to create a predetermined overall color appearance comprising three or more different colors where the outer layers are at least one of translucent and/or transparent.

Swirl patterns have been created and incorporated inside of golf balls by either mixing differently color monomers or prepolymers into the entire composition before setting or curing, or else by stacking differently colored sheets having varying thicknesses followed by milling the sheets to adhere the sheets together and then extruding the sheets through a tubing machine to create a chord of material having the spiral pattern. See U.S. Pat. No. 8,617,004 of Morgan et al. at FIG. 10 and Col. 14, lines 18-44.

However, there is a need for golf balls and methods for making golf balls having a unique and arbitrary/random color appearance this is formed directly into a shallow depth of at least a portion of a core/layer surface. The golf balls and methods of the invention address and solve this need.

### SUMMARY OF THE INVENTION

Accordingly, a golf ball of the invention has an overall color appearance formed from the following steps. A cover material for forming a golf ball cover is provided having a first color appearance that contributes to the overall color appearance. A color material having a second color appearance that contributes to the overall color appearance is applied in discrete locations on a surface of a mold. The cover material is provided into the mold adjacent the color material, and a cover molding process is performed to form a molded cover surface such that: during the cover molding process the color material is transferred to the cover material and incorporated into the molded cover surface; and the molded cover surface comprises at least the first color appearance and the second color appearance, wherein the first color appearance is different than the second color appearance.

The first color appearance may for example have at least one of a different lightness, chroma, hue, saturation, tint, shade, tone, and/or luma than the second color appearance. In one embodiment, at least one of the first color appearance and the second color appearance comprises at least one of colored flakes, particulates, glitter specs, whiskers, fibers, edge effect pigments and filaments. Further, at least one of the first color appearance and the second color appearance may comprise a pearlescent pigment. Moreover, at least one of the first color appearance and the second color appearance may comprise a fluorescent dye.

In one embodiment, a portion of the molded cover has a third color appearance comprising the first color appearance and the second color appearance.

In one embodiment, the second color appearance comprises at least one hue that differs from at least one hue of the first color appearance by from about lnm to about 25 nm. In another embodiment, the second color appearance comprises at least one hue that differs from at least one hue of the first color appearance by from about 15 nm to about 75 nm. In yet another embodiment, the second color appearance comprises at least one hue that differs from at least one hue of the first color appearance by from about 55 nm to about 250 nm. In still another embodiment, the second color appearance comprises at least one hue that differs from at least one hue of the first color appearance by at least about 100 nm.

At least one of the steps of applying the color material to the mold and performing a cover molding process may create a variation in the second color appearance. In this regard, the variation may for example comprise a change in at least one of lightness, chroma, hue, saturation, tint, shade, tone, depth, intensity and/or luma within the second color appearance.

The step of applying the color material to the mold may comprise a single process step selected from the group consisting of dusting, wiping, dropping, splattering, and brushing. Alternatively, the step of applying the color material to the mold may comprise multiple process steps selected from the group consisting of at least two of dusting, wiping, dropping, splattering, and brushing. A suitable cover molding process may be selected from the group consisting of compression molding, injection molding, and casting.

Alternatively, a golf ball of the invention has an overall color appearance formed as follows. A cover material for forming a golf ball cover is provided having a first color appearance that contributes to the overall color appearance. A color material having a second color appearance that contributes to the overall color appearance is applied in discrete locations on a surface of a mold. The cover material is provided into the mold adjacent the color material, and a cover molding process is performed to form a molded cover surface such that: during the cover molding process the color material is transferred to the cover material from the mold and incorporated into the molded cover surface; and the molded cover surface has regions of discrete color comprising the color material, wherein the regions of discrete color are different from the first color appearance of the cover material.

In yet another embodiment, a golf ball of the invention has an overall color appearance formed from the following steps. An intermediate layer material is provided for forming a golf ball intermediate layer having a first color appearance that contributes to the overall color appearance. A color material having a second color appearance that contributes to the overall color appearance is applied in discrete locations on a surface of a mold. The intermediate layer material is provided into the mold adjacent the color material, and performing a molding process to form a molded intermediate layer surface such that: during the molding process the color material is transferred to the intermediate layer material from the mold and incorporated into the molded intermediate layer surface; and the molded intermediate layer surface comprises at least the first color appearance and the second color appearance, wherein the first color appearance is different than the second color appearance; and forming a transparent or translucent cover about the intermediate layer.

A golf ball of the invention has an overall golf ball color appearance that is produced from a cover layer surface comprising a cover material and a color material. The color material is adjacent to the cover material prior to molding the cover material; and the color material is transferred into the cover material and incorporated into discrete regions of the cover layer surface during molding. The cover layer surface, following molding, is comprised of at least two color appearances including a first color appearance of the cover material and a second color appearance of the color material, wherein the first color appearance is different than the second color appearance.

### DETAILED DESCRIPTION

Thus, in a golf ball of the invention, the outer surface of a core/layer incorporating one or more discrete yet arbitrary/random smear(s), line(s), dot(s), brush-stroke(s), burst(s) or other deposits of color material therein. As used herein, the term “core/layer” includes any golf ball component having an outer surface into which the color material may be formed.

The discrete yet arbitrary/random and often impressionistic color appearance of a golf ball of the invention is especially facilitated, for example, where: (i) the layer material and the color material are compatible- e.g., a polyethylene powder color material formed into a surlyn cover material; (ii) the core/layer material and the color material are similar—e.g., Nucrel powder in Surlyn; and/or (iii) the core/layer material and the color material are substantially the same composition—e.g., Surlyn 7940 powder in a cover blended of Surlyns 7940 and 8940. In such cases, after the mold closes and the cover material begins to flow, the color material(s) and layer material(s) will behave similarly, thereby facilitating incorporation of the color materials(s) into the surface.

One additional benefit of a golf ball of the invention is that a much smaller amount or volume of colorant is needed to create a contrasting surface color appearance, as compared, for example, with prior golf balls wherein colorants are mixed into the entire core/layer formulation.

An arbitrary/random color appearance may be formed into the entire outer surface of the core/layer (full coverage), or alternatively, be formed into only a portion thereof (partial coverage). Both full and partial coverage embodiments can include application of a single hue onto a mold surface or alternatively, application of multiple hues.

Even where the arbitrary/random color appearance comprises a single hue, that single hue may vary or transition throughout the color material-deposited surface in terms of lightness, chroma, saturation, tint, shade, tone, and/or luma. Furthermore, multiple color materials, each having a different hue, may at least partially superimpose each other. Alternativley, multiple differently colored color materials may in some embodiments form into separate/distinct and non-intersecting areas on the core/layer surface

Meanwhile, an arbitrary/random color appearance comprising greater than two different hues may result even where only two differently colored materials are applied. For example, a red translucent color material and a blue translucent color material may each be applied into a portion of the mold such that when yellow colored cover material is provided into the mold adjacent the color material, and a cover molding process is performed, the molded cover surface may have an arbitrary/random color appearance comprising at least yellow (in area of the cover not having the color material formed therein), orange and green hues, and possibly an additional hue from any overlap of the orange translucent color materials and the green translucent color materials within the outer surface.

In a different embodiment, the two different red and blue translucent color materials may be introduced onto the entire mold surface such that when the yellow colored cover material is provided into the mold adjacent the color material, and a cover molding process is performed, a molded cover surface is formed wherein an arbitrary/random color appearance results comprising at least: orange, green, and any hue resulting from any overlap of the orange translucent color material and the green translucent color material within the outer surface. In this full coverage embodiment, the yellow of the cover material is not visually apparent on the surface of the golf ball.

Meanwhile, a “color gradient”, or variations in individual color strength and distribution of multiple colors on the core/layer outer surface may be created during the molding process. In one non-limiting approach, where the mold parts have a non-uniform thickness, some of the color material may be pressured/forced to migrate along the outer surface during molding before forming therein such that the arbitrary/random color appearance is visually darker in some portions of the surface and lighter in other portions of the surface.

In fact, such color appearance “gradients” may be created in the outer surface for golf ball identification purposes as well. In this embodiment, a custom golf ball may be made incorporating the color material into a cover surface in the formation of a player's finger print.

It is contemplated that the color material may comprise any form suitable for transferring to the outer surface and forming within it—including, for example, powder, ink, print, regrind, liquids, gels in addition to powder. It is also contemplated that the color material may be transferred to and formed within any golf ball component surface, including inner surfaces of golf ball components in some embodiments.

Strong variations in color on the molded surface may be achieved by increasing the density of color material applied into the mold. Even a plurality of fairly pale hues may contain graduations in color intensity by varying the density of color material applied to the mold.

Golf balls of the invention may be formed from via golf ball manufacturing methods or processes or techniques known in the art such as compression molding, injection molding, and/or casting, etc. In a casting process, casting liquid material is poured into a mold, which contains a hollow cavity of the desired shape, and then allowed to solidify. The solidified part is also known as a casting, which is ejected or broken out of the mold to complete the process. Thermoset materials are often formed into golf ball layers by conventional casting or reaction injection molding techniques. Thermoplastic materials, meanwhile, are often formed into golf ball layers by conventional compression or injection molding techniques.

For example, the transfer of colored powdered material to the mold can be accomplished through a variety of techniques. It can be sprinkled, dusted or blown onto a mold surface, for example. A pallet having many colors may be brushed onto the mold to apply color lightly to the mold surface in an impressionistic design. A spray technique is also possible. In particular, electrostatic spray (similar to powder coating) may be particularly useful.

In one embodiment, the color material is a powder that is pretreated before being applied to the mold to promote a light adhesion of the powder to the surface of the mold so that the intended pattern in which the powder is applied to the mold transfers to the layer surface. In another embodiment, a “shadow” may be created—either in or around a dimple on all or a portion of the ball.

Where a golf ball component is removed from the mold and its surface post-molding treated using techniques such as corona discharge, sand blasting, or grinding to improve adhesion of the surrounding layers, precautions should be taken in some cases to ensure that the arbitrary/random color appearance is not removed from the core/layer surface there during. Alternatively, embodiments are envisioned wherein such post-molding treatments might actually be used to contribute to or further enhance the visual effect of the arbitrary/random color appearance on the core/layer outer surface—such as to create variations in texture. Meanwhile, the golf balls produced may undergo various further processing steps such as buffing, painting and marking using conventional techniques to produce a finished ball having a desired overall golf ball appearance.

With regard to the size of particulates in powdered color materials, any size is contemplated which transfers to a mold and forms within a golf ball surface to produce an observable (aesthetic) benefit without sacrificing golf ball durability.

Any color may be used for the cover material and any degree of opacity is possible. Any hue may be used for the color material. Combinations of hues may be preferable in some cases. The colors selected may additionally be florescent, or luminescent. “Glow in the Dark” pigments are relatively expensive and could be used in lesser amounts with this technique. Special effect pigments can be employed to create metallic or pearlescent appearances. A requirement is that a contrast is created between the portions of the cover affected by the application of the color material(s) and the portion of the surface not affected. In some cases the entire outer surface will be affected and only the inner surface remains unaltered. In other cases, only a portion of the outer surface is affected. Different regions of the cover surface might be affected differently by alterations in the application of different colored materials. For more transparent covers, the greater the density of the application of colored powdered material, the less transparent the affected cover regions will be.

It will be appreciated that the wavelength change necessary to achieve a color/hue difference will vary depending on the two colors in question. This is because some colors occupy broader wavelength ranges than others on the spectrum. For example, violet and yellow each occupy a distance of about 30 nm on the spectrum, whereas orange, blue, green and red each occupy about 40 nm, 50 nm, 80 nm and 120 nm thereon, respectively.

Thus, for example, violet and blue (adjacent each other on the spectrum) may differ by up to 80 nm, while blue and green may differ by up to about 130 nm; green and yellow may differ by up to about 110 nm; and yellow and orange may differ by up to about 70 nm (these pairs also being adjacent each other). Meanwhile, violet and red may differ by up to about 350 nm (non-adjacent on the spectrum), while yellow and non-adjacent red may differ by up to about 160 nm, etc.

In one embodiment, the second color appearance comprises at least one hue that differs from at least one hue of the first color appearance by from about lnm to about 400 nm. In another embodiment, the second color appearance comprises at least one hue that differs from at least one hue of the first color appearance by from about lnm to about 25 nm. In yet another embodiment, the second color appearance comprises at least one hue that differs from at least one hue of the first color appearance by from about 15 nm to about 75 nm. In still another embodiment, the second color appearance comprises at least one hue that differs from at least one hue of the first color appearance by from about 55 nm to about 250 nm. In an alternative embodiment, the second color appearance comprises at least one hue that differs from at least one hue of the first color appearance by from about 100 nm to about 325 nm. In a different embodiment, the second color appearance comprises at least one hue that differs from at least one hue of the first color appearance by at least about 300 nm.

It is contemplated that the depth of the color material deposit into the core/layer surface is less that the diameter or thickness of the core/layer. In this regard, the color material may be formed into the core/layer outer surface in any shallow depth suitable to meanwhile preserve overall golf ball durability.

The cover of the golf ball of the present invention may comprise any known color and optionally comprise surface off-sets, or depressions or projections, on its surface. Surface off-sets include dimples and marking other than dimples. For instance, the surface of the translucent cover may comprise depressed logos, text, lines, arcs, circles or polygons. The surface may also comprise raised projections in the form of logos, text, lines, arcs, circles or polygons. The inclusion of such surface off-sets on the translucent cover creates a unique visual effect, as the juxtaposition of thick and thin portions of the translucent cover material creates a “shadow” effect on the opaque surface below the translucent cover.

A golf ball of the invention may comprise any construction known in the art, generally comprising components including a core surrounded by a cover and optionally intermediate layers there between. The core and/or the cover may incorporate multiple layers and the core may be solid or have a fluid-filled center surrounded by windings and/or molded material.

Golf ball components may be formed from a variety of materials such as balata, polybutadiene, polyurethane, polyurea, thermoplastic compositions, and ionomer resins such as SURLYN® and IOTEK®, depending upon the desired performance characteristics of the golf ball and desired properties of the cover. Thermoplastic cover materials are particularly suitable, but any cover material which softens or otherwise enters a fluid state during the molding process is also contemplated. A Surlyn covered golf ball is one example.

Cores may for example be made from a composition including at least one thermoset base rubber, such as a polybutadiene rubber, cured with at least one peroxide and at least one reactive co-agent, which can be a metal salt of an unsaturated carboxylic acid, such as acrylic acid or methacrylic acid, a non-metallic coagent, or mixtures thereof. Preferably, a suitable antioxidant is included in the composition. An optional soft and fast agent (and sometimes a cis-to-trans catalyst), such as an organosulfur or metal-containing organosulfur compound, can also be included in the core formulation.

Other ingredients that are known to those skilled in the art may be used, and are understood to include, but not be limited to, density-adjusting fillers, process aides, plasticizers, blowing or foaming agents, sulfur accelerators, and/or non-peroxide radical sources.

The base thermoset rubber, which can be blended with other rubbers and polymers, typically includes a natural or synthetic rubber. For example, the base rubber may be 1,4-polybutadiene having a cis structure of at least 40%, preferably greater than 80%, and more preferably greater than 90%.

Examples of desirable polybutadiene rubbers include BUNA® CB22 and BUNA® CB23, commercially available from LANXESS Corporation; UBEPOL® 360L and UBEPOL® 150L and UBEPOL-BR rubbers, commercially available from UBE Industries, Ltd. of Tokyo, Japan; BUDENE 1208, 1207, commercially available from Goodyear of Akron, Ohio; and CB BUNA® 1203G1, 1220, and 1221, commercially available from Dow Chemical Company; Europrene® NEOCIS® BR 40 and BR 60, commercially available from Polimeri Europa; and BR 01, BR 730, BR 735, BR 11, and BR 51, commercially available from Japan Synthetic Rubber Co., Ltd; and KARBOCHEM® ND40, ND45, and ND60, commercially available from Karbochem.

In one embodiment of the present invention, golf ball cores made with mid- to high-Mooney viscosity polybutadiene material exhibit increased resiliency (and, therefore, distance) without increasing the hardness of the ball. Such cores are soft, i.e., compression less than about 60 and more specifically in the range of about 50-55. Cores with compression in the range of from about 20 about 50 are also within the range of this preferred embodiment.

The thermoset rubber composition in a core of the golf ball of the present invention may also include an optional soft and fast agent. As used herein, “soft and fast agent” means any compound or a blend thereof that that is capable of making a core 1) be softer (lower compression) at constant COR or 2) have a higher COR at equal compression, or any combination thereof, when compared to a core equivalently prepared without a soft and fast agent. Preferably, the composition of the present invention contains from about 0.05 phr to about 10.0 phr soft and fast agent. In one embodiment, the soft and fast agent is present in an amount of about 0.05 phr to about 3.0 phr, preferably about 0.05 phr to about 2.0 phr, more preferably about 0.05 phr to about 1.0 phr. In another embodiment, the soft and fast agent is present in an amount of about 2.0 phr to about 5.0 phr, preferably about 2.35 phr to about 4.0 phr, and more preferably about 2.35 phr to about 3.0 phr. In an alternative high concentration embodiment, the soft and fast agent is present in an amount of about 5.0 phr to about 10.0 phr, more preferably about 6.0 phr to about 9.0 phr, most preferably about 7.0 phr to about 8.0 phr. In another embodiment, the soft and fast agent is present in an amount of about 2.6 phr.

Suitable soft and fast agents include, but are not limited to, organosulfur or metal-containing organosulfur compounds, an organic sulfur compound, including mono, di, and polysulfides, a thiol, or mercapto compound, an inorganic sulfide compound, a Group VIA compound, or mixtures thereof. The soft and fast agent component may also be a blend of an organosulfur compound and an inorganic sulfide compound.

Fillers may also be added to the thermoset rubber composition of the core to adjust the density of the composition, up or down. Typically, fillers include materials such as tungsten, zinc oxide, barium sulfate, silica, calcium carbonate, zinc carbonate, metals, metal oxides and salts, regrind (recycled core material typically ground to about 30 mesh particle), high-Mooney-viscosity rubber regrind, trans-regrind core material (recycled core material containing high trans-somer of polybutadiene), and the like. When trans-regrind is present, the amount of trans-somer is preferably between about 10% and about 60%. In one embodiment of the invention, the core comprises polybutadiene having a cis-isomer content of greater than about 95% and trans-regrind core material (already vulcanized) as a filler. Any particle size trans-regrind core material is sufficient, but is preferably less than about 125 μm.

Fillers added to one or more portions of the golf ball typically include processing aids or compounds to affect rheological and mixing properties, density-modifying fillers, tear strength, or reinforcement fillers, and the like. The fillers are generally inorganic, and suitable fillers include numerous metals or metal oxides, such as zinc oxide and tin oxide, as well as barium sulfate, zinc sulfate, calcium carbonate, barium carbonate, clay, tungsten, tungsten carbide, an array of silicas, and mixtures thereof. Fillers may also include various foaming agents or blowing agents which may be readily selected by one of ordinary skill in the art. Fillers may include polymeric, ceramic, metal, and glass microspheres may be solid or hollow, and filled or unfilled. Fillers are typically also added to one or more portions of the golf ball to modify the density thereof to conform to uniform golf ball standards. Fillers may also be used to modify the weight of the center or at least one additional layer for specialty balls, e.g., a lower weight ball is preferred for a player having a low swing speed.

Materials such as tungsten, zinc oxide, barium sulfate, silica, calcium carbonate, zinc carbonate, metals, metal oxides and salts, and regrind (recycled core material typically ground to about 30 mesh particle) are also suitable fillers.

In one embodiment, an intermediate layer is formed from an ionomeric material including ionomeric polymers, preferably highly-neutralized ionomers (HNP). In another embodiment, the intermediate layer of the golf ball is formed from an HNP material or a blend of HNP materials. The acid moieties of the HNP's, typically ethylene-based ionomers, are preferably neutralized greater than about 70%, more preferably greater than about 90%, and most preferably at least about 100%. The HNP's can be also be blended with a second polymer component, which, if containing an acid group, may also be neutralized. The second polymer component, which may be partially or fully neutralized, preferably comprises ionomeric copolymers and terpolymers, ionomer precursors, thermoplastics, polyamides, polycarbonates, polyesters, polyurethanes, polyureas, thermoplastic elastomers, polybutadiene rubber, balata, metallocene-catalyzed polymers (grafted and non-grafted), single-site polymers, high-crystalline acid polymers, cationic ionomers, and the like. HNP polymers typically have a material hardness of between about 20 and about 80 Shore D, and a flexural modulus of between about 3,000 psi and about 200,000 psi.

Non-limiting examples of suitable ionomers include partially neutralized ionomers, blends of two or more partially neutralized ionomers, highly neutralized ionomers, blends of two or more highly neutralized ionomers, and blends of one or more partially neutralized ionomers with one or more highly neutralized ionomers. Methods of preparing ionomers are well known, and are disclosed, for example, in U.S. Pat No. 3,264,272, the entire disclosure of which is hereby incorporated herein by reference. The acid copolymer can be a direct copolymer wherein the polymer is polymerized by adding all monomers simultaneously, as disclosed, for example, in U.S. Pat No. 4,351,931, the entire disclosure of which is hereby incorporated herein by reference. Alternatively, the acid copolymer can be a graft copolymer wherein a monomer is grafted onto an existing polymer, as disclosed, for example, in U.S. Patent Application Publication No. 2002/0013413, the entire disclosure of which is hereby incorporated herein by reference.

Any golf ball component, namely core, intermediate layer, cover, etc. may also be formed from or comprise or include or be blended or otherwise combined or mixed with any of the following compositions as known in the art to achieve particular desired golf ball characteristics:
(1) Polyurethanes, such as those prepared from polyols and diisocyanates or polyisocyanates and/or their prepolymers, and those disclosed in U.S. Pat. Nos. 5,334,673 and 6,506,851;
(2) Polyureas, such as those disclosed in U.S. Pat. Nos. 5,484,870 and 6,835,794; and
(3) Polyurethane-urea hybrids, blends or copolymers comprising urethane or urea segments.

Suitable polyurethane compositions comprise a reaction product of at least one polyisocyanate and at least one curing agent. The curing agent can include, for example, one or more polyols. The polyisocyanate can be combined with one or more polyols to form a prepolymer, which is then combined with the at least one curing agent. Thus, the polyols described herein are suitable for use in one or both components of the polyurethane material, i.e., as part of a prepolymer and in the curing agent. Suitable polyurethanes are described in U.S. Pat. No. 7,331,878, which is incorporated herein in its entirety by reference.

Meanwhile, the dimensions of each golf ball component such as the diameter of the core and respective thicknesses of the intermediate layer (s), cover layer(s) and coating layer(s) may be selected and coordinated as known in the art for targeting and achieving desired playing characteristics or feel. For example, the core may have a diameter of from about 1.47 inches (in.) to about 1.55 in. The intermediate layer may have a thickness of from about 0.025 in. to about 0.057 in. The core and intermediate layer, combined, may have a diameter of from about 1.57 in. to about 1.65 in. The cover may have a thickness of from about 0.015 in. to about 0.055 in. The coating layers may have a combined thickness, for example, of from about 0.1 μm to about 100 μm, or from about 2 μm to about 50 μm, or from about 2 μm to about 30 μm. Meanwhile, each coating layer may have a thickness of from about 0.1 μm to about 50 μm, or from about 0.1 μmto about 25 μm, or from about 0.1 μm to about 14 μm, or from about 2 μm to about 9 μm.

While any of the embodiments herein may have any known dimple number and pattern, such as a number of dimples being 252 to 456, or 330 to 392. The dimples may comprise any width, depth, and edge angle disclosed in the prior art and the patterns may comprises multitudes of dimples having different widths, depths and edge angles. The parting line configuration of said pattern may be either a straight line or a staggered wave parting line (SWPL). Most preferably the dimple number is 330, 332, or 392 and comprises 5 to 7 dimples sizes and the parting line is a SWPL.

In any of these embodiments the single-layer core may be replaced with a 2 or more layer core wherein at least one core layer has a hardness gradient.

Other than in the operating examples, or unless otherwise expressly specified, all of the numerical ranges, amounts, values and percentages such as those for amounts of materials and others in the specification may be read as if prefaced by the word “about” even though the term “about” may not expressly appear with the value, amount or range. Accordingly, unless indicated to the contrary, the numerical parameters set forth in the specification and attached claims are approximations that may vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contain certain errors necessarily resulting from the standard deviation found in their respective testing measurements. Furthermore, when numerical ranges of varying scope are set forth herein, it is contemplated that any combination of these values inclusive of the recited values may be used.

While it is apparent that the illustrative embodiments of the invention disclosed herein fulfill the objective stated above, it is appreciated that numerous modifications and other embodiments may be devised by those skilled in the art. Therefore, it will be understood that the appended claims are intended to cover all such modifications and embodiments, which would come within the spirit and scope of the present invention.

1. A golf ball having an overall color appearance formed from the steps comprising:
providing a cover material for forming a golf ball cover and having a first color appearance that contributes to the overall color appearance;
applying a color material having a second color appearance that contributes to the overall color appearance in discrete yet arbitrary/random locations on a surface of a mold;
providing the cover material into the mold adjacent the color material;
performing a cover molding process to form a molded cover surface such that:
during the cover molding process the color material is transferred to the cover material and incorporated into discrete yet arbitrary/random regions of the molded cover surface to a depth that is less than a thickness of the cover; and
the molded cover surface comprises at least the first color appearance of the cover material and the second color appearance of the color material in discrete yet arbitrary/random regions of the cover surface having a depth that is less than the thickness of the cover, wherein the first color appearance is different than the second color appearance.

2. The golf ball of claim 1, wherein the first color appearance has at least one of a different lightness, chroma, hue, saturation, tint, shade, tone, and/or luma than the second color appearance.

3. The golf ball of claim 1, wherein at least one of the first color appearance and the second color appearance comprises at least one of colored flakes, particulates, glitter specs, whiskers, fibers, edge effect pigments and filaments.

4. The golf ball of claim 1, wherein at least one of the first color appearance and the second color appearance comprises a pearlescent pigment.

5. The golf ball of claim 1, wherein at least one of the first color appearance and the second color appearance comprises a fluorescent dye.

6. The golf ball of claim 1, wherein a portion of the molded cover comprises a third color appearance comprising the first color appearance and the second color appearance.

7. The golf ball of claim 1, wherein the second color appearance comprises at least one hue that differs from at least one hue of the first color appearance by from about 1 nm to about 25 nm.

8. The golf ball of claim 1, wherein the second color appearance comprises at least one hue that differs from at least one hue of the first color appearance by from about 15 nm to about 75 nm.

9. The golf ball of claim 1, wherein the second color appearance comprises at least one hue that differs from at least one hue of the first color appearance by from about 55 nm to about 250 nm.

10. The golf ball of claim 1, wherein the second color appearance comprises at least one hue that differs from at least one hue of the first color appearance by at least about 100 nm.

11. The golf ball of claim 1, wherein at least one of the steps of applying the color material to the mold and performing a cover molding process creates a variation in the second color appearance.

12. The golf ball of claim 11, wherein the variation comprises a change in at least one of lightness, chroma, hue, saturation, tint, shade, tone, depth, intensity and/or luma within the second color appearance.

13. The golf ball of claim 1, wherein the step of applying the color material to the mold comprises a single process step selected from the group consisting of dusting, wiping, dropping, splattering, and brushing.

14. The golf ball of claim 1, wherein step of applying the color material to the mold comprises multiple process steps selected from the group consisting of at least two of dusting, wiping, dropping, splattering, and brushing.

15. The golf ball of claim 1, wherein the cover molding process is selected from the group consisting of compression molding; injection molding; and casting.

16. A golf ball having an overall color appearance formed from the steps comprising:
providing a cover material for forming a golf ball cover and having a first color appearance that contributes to the overall color appearance;
applying a color material having a second color appearance that contributes to the overall color appearance in discrete yet arbitrary/random locations on a surface of a mold;
providing the cover material into the mold adjacent the color material;
performing a cover molding process to form a molded cover surface such that:
during the cover molding process the color material is transferred to the cover material from the mold and incorporated into discrete yet arbitrary/random regions of the molded cover surface to a depth that is less than a thickness of the cover; and
the molded cover surface has regions of discrete yet arbitrary/random color comprising the color material, wherein the regions of discrete yet arbitrary/random color have a depth that is less than the thickness of the cover and are different from the first color appearance of the cover material.

17. A golf ball having an overall color appearance formed from the steps comprising:
providing an intermediate layer material for forming a golf ball intermediate layer and having a first color appearance that contributes to the overall color appearance;
applying color material having a second color appearance that contributes to the overall color appearance in discrete yet arbitrary/random locations on a surface of a mold to a depth that is less than a thickness of the intermediate layer;
providing the intermediate layer material into the mold adjacent the color material; and
performing a molding process to form a molded intermediate layer surface such that:
during the molding process the color material is transferred to the intermediate layer material from the mold and incorporated into discrete yet arbitrary/random regions of the molded intermediate layer surface to a depth that is less than a thickness of the intermediate layer; and
the molded intermediate layer surface comprises at least two color appearances including the first color appearance of the intermediate layer material and the second color appearance of the color material that is formed in discrete yet arbitrary/random regions of the intermediate layer surface to a depth that is less than a thickness of the intermediate layer, wherein the first color appearance is different than the second color appearance; and
forming a transparent or translucent cover about the intermediate layer.

18. A golf ball having an overall golf ball color appearance that is produced from a cover layer surface comprising a cover material and a color material;
wherein the color material is adjacent to the cover material prior to molding the cover material; and
wherein the color material is transferred into the cover material and incorporated into discrete yet arbitrary/random regions of the cover layer surface during molding to a depth that is less than a thickness of the cover;
such that the cover layer surface, following molding, is comprised of at least two color appearances including a first color appearance of the cover material and a second color appearance of the color material that is formed in discrete yet arbitrary/random regions of the cover layer surface to a depth that is less than a thickness of the cover, wherein the first color appearance is different than the second color appearance.

19. The golf ball of claim 18, wherein molding comprises a process selected from the group consisting of compression molding; injection molding; and casting.

20. The golf ball of claim 18, wherein the color material is adjacent to the cover material in a mold prior to molding the cover material.

21. The golf ball of claim 18, wherein the color material is provided to the mold by at least one process step selected from the group consisting of dusting, wiping, dropping, splattering, and brushing.
